(19) United States
(12) Patent Application Publication
(10) Pub. No.: US 2025/0327475 A1
(43) Pub. Date: Oct. 23, 2025

(54) SCREW

(71) Applicant: TAIWAN SHAN YIN INTERNATIONAL CO., LTD., KAOHSIUNG CITY (TW)

(72) Inventors: KOU-TSAIR SU, KAOHSIUNG CITY (TW); CHEN-LONG SU, KAOHSIUNG CITY (TW)

(21) Appl. No.: 18/639,042

(22) Filed: Apr. 18, 2024

(51) Int. Cl. F16B 25/00

(52) U.S. Cl. CPC F16B 25/0042

(57) ABSTRACT

A screw includes thread convolutions spirally disposed around a shank. Each thread convolution has a thread crest formed along a junction of opposite upper and lower thread flanks. Notches are recessed into the thread crest of at least one thread convolution. Each lower thread flank includes a first lower flank section and a third lower flank section extended in a curved manner and includes a second lower flank section extending between the first and the third lower flank section in a non-curved manner. Accordingly, the third lower flank section cuts a workpiece sharply and allows cut chips to travel along the first lower flank section, the third lower flank section, and the notches, thereby attaining a quick removal and proper accumulation of chips. The second lower flank section provides supporting force, thereby increasing the strength of the thread convolutions, improving the cutting capability, and reducing the screwing resistance.

### BACKGROUND OF THE INVENTION

### 1. Field of the Invention

This invention relates to a screw and relates particularly to a screw with different thread flanks which are provided with different flank sections respectively.

### 2. Description of the Related Art

Referring to FIGS. 1 and 2, the US patent application publication no. 2023/0048078 discloses a conventional screw 1 comprising a head 11, a shank 12 extending outwards from the head 11, and a threaded portion 13 spirally disposed on the shank 12. The threaded portion 13 has a plurality of thread convolutions 13A spirally formed on the shank 12 and spaced apart from each other. Each thread convolution 13A has two opposite first flank sections 131 extending from the shank 12, two opposite second flank sections 132 extending from the first flank sections 131 respectively, two opposite third flank sections 133 extending from the second flank sections 132 respectively, a thread crest 134 formed along a junction of the third flank sections 133, and a plurality of notches 135 recessed into the thread crest 134 of at least one thread convolution 13A. A first thread angle θ1 is defined between the first flank sections 131 and ranges from 70 degrees to 75 degrees. A second thread angle θ2 is defined between the second flank sections 132 and ranges from 37 degrees to 43 degrees. A third thread angle θ3 is defined between the third flank sections 133 and ranges from 20 degrees to 23 degrees.

Referring to FIGS. 1 to 3, during a screwing operation, the head 11 receives a rotational force in order that the thread convolutions 13A are allowed to cut into a workpiece 2. The first, second, and third angles θ1, θ2, θ3 defined by the first, second, and third flank sections 131, 132, 133 respectively allow the thread convolutions 13A to cut the workpiece 2 sharply, thereby reducing the screwing resistance, allowing the screw 1 to screw into the workpiece 2 quickly, and attaining a positioning effect.

However, the first flank sections 131 are extended in a symmetric manner and have respective first sloped surfaces in cross-section. The second and the third flank sections 132, 133 are also extended in a symmetric manner and have respective second and third sloped surfaces in cross-section. Although the different first, second, and third angles θ1, θ2, θ3 attain effects of improving the cutting sharpness and the screwing resistance, the inventors found that the current screw 1 is not ideal enough and made a further improvement, thereby proposing the improved screw 3.

### SUMMARY OF THE INVENTION

The object of this invention is to provide a screw capable of increasing cutting capability while reducing screwing resistance, enhancing the strength of threaded portion, and improving a screwing effect.

The screw of this invention comprises a head, a shank extending outwards from the head, and a threaded portion spirally formed on the shank. The threaded portion has a plurality of thread convolutions spirally disposed on the shank. Each thread convolution has an upper thread flank and a lower thread flank extending outwards from the shank and opposite to each other, and a thread crest formed along a junction of the upper thread flank and the lower thread flank. A plurality of notches is recessed into the thread crest of at least one thread convolution. Each notch has a chip-guiding surface cut into the thread crest and two cutting edges formed along an outer periphery of the chip-guiding surface. Each upper thread flank has a first upper flank section extending outwards from the shank, a second upper flank section connected to the first upper flank section, and a third upper flank section connected to the second upper flank section and extended to the thread crest. Each lower thread flank has a first lower flank section extending outwards from the shank, a second lower flank section connected to the first lower flank section, and a third lower flank section connected to the second lower flank section and extended to the thread crest. Each first lower flank section and each third lower flank section are curved in shape respectively whereby the first lower flank section and the third lower flank section have respective curved surfaces in cross-section. Each second lower flank section extends between relative first and third lower flank sections without curving whereby the second lower flank section extends straightly to be in a non-curved form in cross-section. The upper and lower thread flanks with respective flank sections that are formed in an asymmetric manner can increase the strength of the threaded portion, advance the cutting capability, and decrease the screwing resistance. The first lower flank section, the third lower flank section, and the notches assist in excluding cut chips quickly and accumulating cut chips duly, thereby attaining a tight engagement. The second lower flank section is capable of providing enough supporting force. The third lower flank section also allows the threaded portion to cut into a workpiece sharply and smoothly, thereby improving the cutting effect and thread strength, attaining a quick screwing operation, and achieving a preferable screwing effect.

Preferably, the second lower flank section has a connecting segment connected to the first lower flank section and a linking segment extending between the connecting segment and the third lower flank section. The connecting segment and the linking segment have respective second lower sloped surfaces which are different from each other.

Preferably, the first upper flank section has an engaging segment connected to the shank and a stretching segment extending between the engaging segment and the second upper flank section. The engaging segment and the stretching segment have respective first upper sloped surfaces which are different from each other.

Preferably, the second upper flank section is extended straightly to provide a second upper sloped surface.

Preferably, the third upper flank section has a cutting segment connected to the second upper flank section and a severing segment extending between the cutting segment and the thread crest. The cutting segment and the severing segment have respective third upper sloped surfaces which are different from each other.

Preferably, the thread convolutions have a first plurality of thread convolutions and a second plurality of thread convolutions. The notches are recessedly formed on the first plurality of thread convolutions. The number of the first plurality of thread convolutions is in the range of one-third (⅓) to one-half (½) of the number of the thread convolutions.

Preferably, the shank defines a plurality of surface sections. Each surface section is situated between any two adjacent thread convolutions when the thread convolutions are axially spaced apart. At least one surface section is recessedly formed to define an annular groove.

### BRIEF DESCRIPTION OF THE DRAWINGS

FIG. 1 is a schematic view showing a conventional screw;

FIG. 2 is a cross-sectional view showing a thread convolution of the conventional screw;

FIG. 3 is a schematic view showing a screwing operation of the conventional screw;

FIG. 4 is a schematic view showing a first preferred embodiment of this invention;

FIG. 5 is an enlarged view of the encircled portion A indicated in FIG. 4;

FIG. 6 is a cross-sectional view showing an upper thread flank of the thread convolution;

FIG. 7 is a cross-sectional view showing a lower thread flank of the thread convolution;

FIG. 8 is a schematic view showing a screwing operation of the first preferred embodiment of this invention;

FIG. 9 is a schematic view showing a second preferred embodiment of this invention characterized by an annular groove; and

FIG. 10 is an enlarged view showing the annular groove of the second preferred embodiment of this invention.

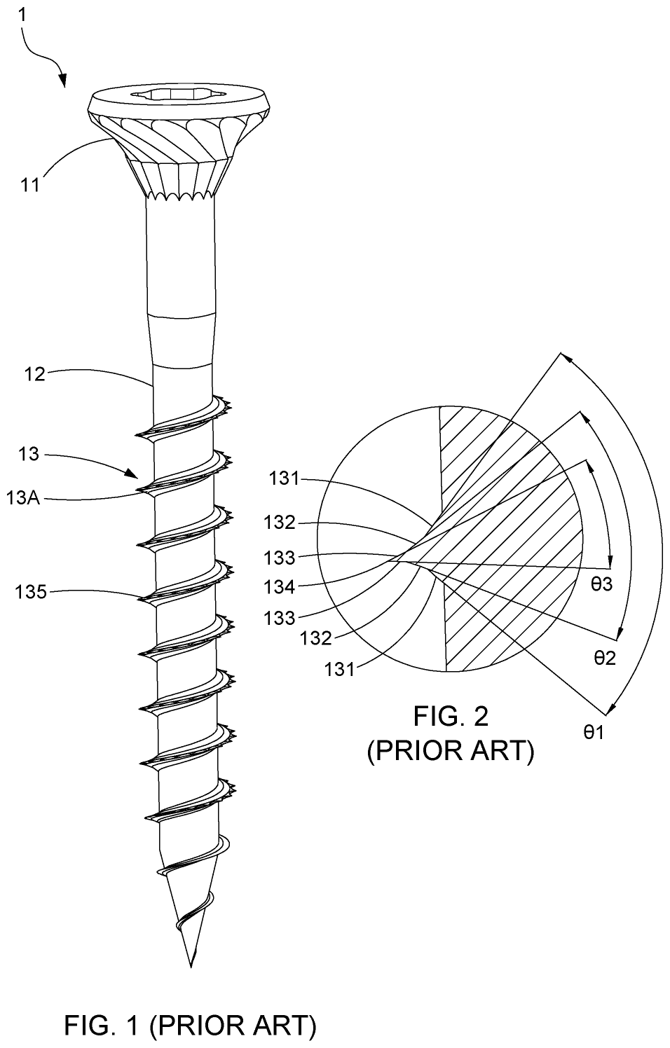

### DETAILED DESCRIPTION OF THE PREFERRED EMBODIMENTS

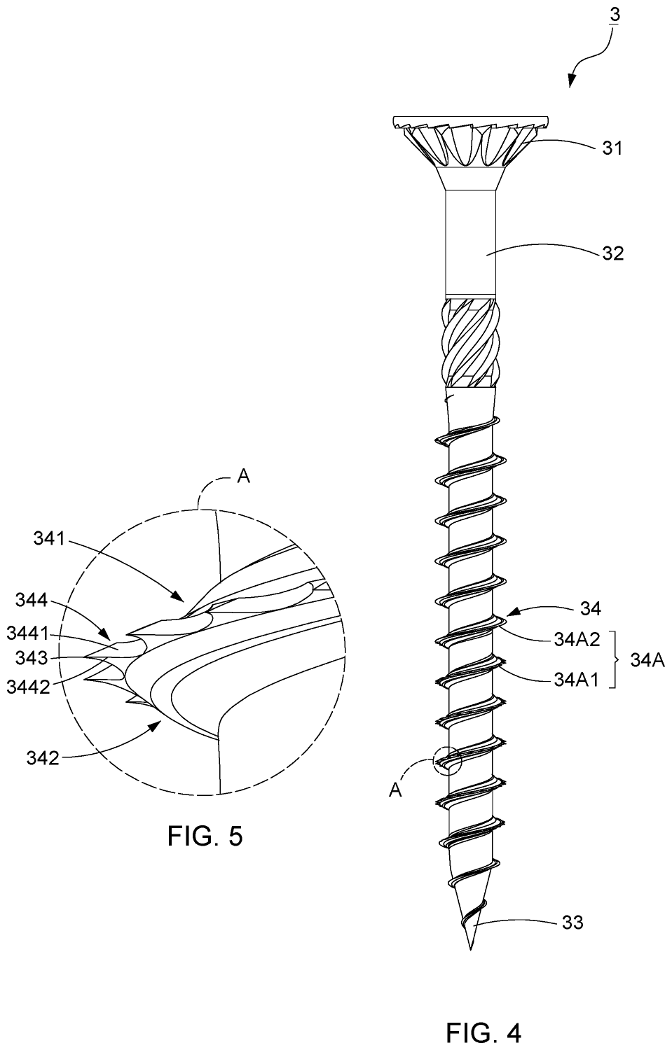

Referring to FIGS. 4 and 5, a first preferred embodiment of a screw 3 of this invention is disclosed. The screw 3 includes a head 31, a shank 32 extending outwards from the head 31, a drill portion 33 formed on the shank 32 and opposite to the head 31, and a threaded portion 34 spirally disposed on the shank 32. The threaded portion 34 has a plurality of thread convolutions 34A spirally formed on the shank 32. Each thread convolution 34A has an upper thread flank 341 extending outwards from the shank 32 and facing toward the head 31, a lower thread flank 342 extending outwards from the shank 32 and facing toward the drill portion 33, and a thread crest 343 formed along a junction of the upper thread flank 341 and the lower thread flank 342. In this preferred embodiment, the thread convolutions 34A have a first plurality of thread convolutions 34A1 and a second plurality of thread convolutions 34A2. A plurality of notches 344 is cut into the thread crest 343 of at least one of the first plurality of thread convolutions 34A1. The second plurality of thread convolutions 34A2 is formed without any notches 344.

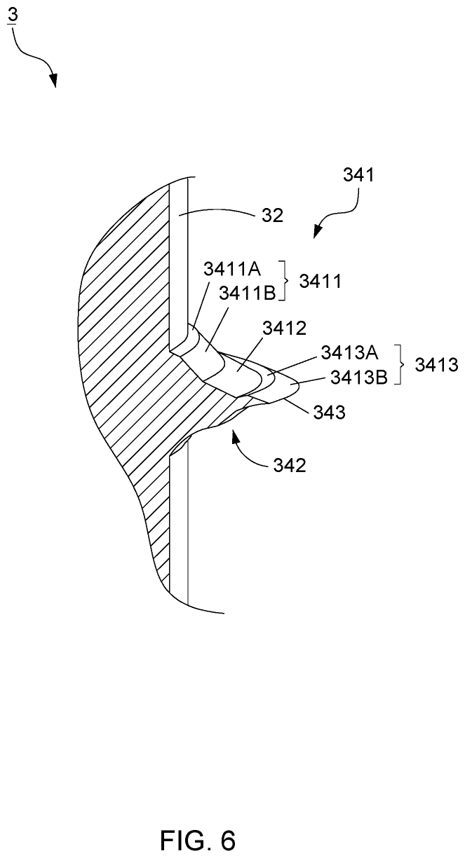

Referring to FIGS. 4, 5 and 6, each upper thread flank 341 has a first upper flank section 3411 connected to the shank 32, a second upper flank section 3412 connected to the first upper flank section 3411, and a third upper flank section 3413 connected to the second upper flank section 3412 and extended to the thread crest 343. The second upper flank section 3412 extends straightly between the first upper flank section 3411 and the third upper flank section 3413 to provide a second upper sloped surface in cross section. Each first upper flank section 3411 has an engaging segment 3411A connected to the shank 32 and a stretching segment 3411B extending between the engaging segment 3411A and the second upper flank section 3412. Each engaging segment 3411A and each stretching segment 3411B extend without curving so that the engaging and the stretching segments 3411A, 3411B have respective first upper sloped surfaces which are different from each other in cross-section. Each third upper flank section 3413 has a cutting segment 3413A connected to the second upper flank section 3412 and a severing segment 3413B extending between the cutting segment 3413A and the thread crest 343. Each cutting segment 3413A and each severing segment 3413B extend without curving so that the cutting and the severing segments 3413A, 3413B have respective third upper sloped surfaces which are different from each other in cross-section.

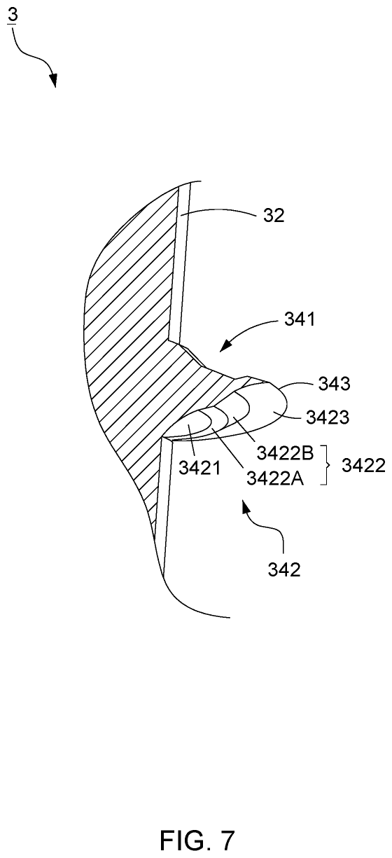

Referring to FIGS. 4, 5 and 7, each lower thread flank 342 has a first lower flank section 3421 connected to the shank 32, a second lower flank section 3422 connected to the first lower flank section 3421, and a third lower flank section 3423 connected to the second lower flank section 3422 and extended to the thread crest 343. Each first lower flank section 3421 and each third lower flank section 3423 are curved in shape respectively so that the first lower flank section 3421 and the third lower flank section 3423 have respective curved surfaces in cross-section. Each second lower flank section 3422 extends between the first lower flank section 3421 and the third lower flank section 3423 without curving so that the second lower flank section 3422 extends straightly to be in a non-curved form in cross section. Each second lower flank section 3422 has a connecting segment 3422A connected to the first lower flank section 3421 and a linking segment 3422B extending between the connecting segment 3422A and the third lower flank section 3423. Each connecting segment 3422A and each linking segment 3422B extend without curving so that the connecting and the linking segments 3422A, 3422B have respective second lower sloped surfaces which are different from each other in cross-section.

Referring to FIGS. 4 and 5, each notch 344 has a chip-guiding surface 3441 recessed into the thread crest 343 and two cutting edges 3442 formed along an outer periphery of the chip-guiding surface 3441. In this preferred embodiment, the number of the first plurality of thread convolutions 34A1 on which the notches 344 are disposed is in the range of one-third (⅓) to one-half (½) of the number of the plurality of thread convolutions 34A.

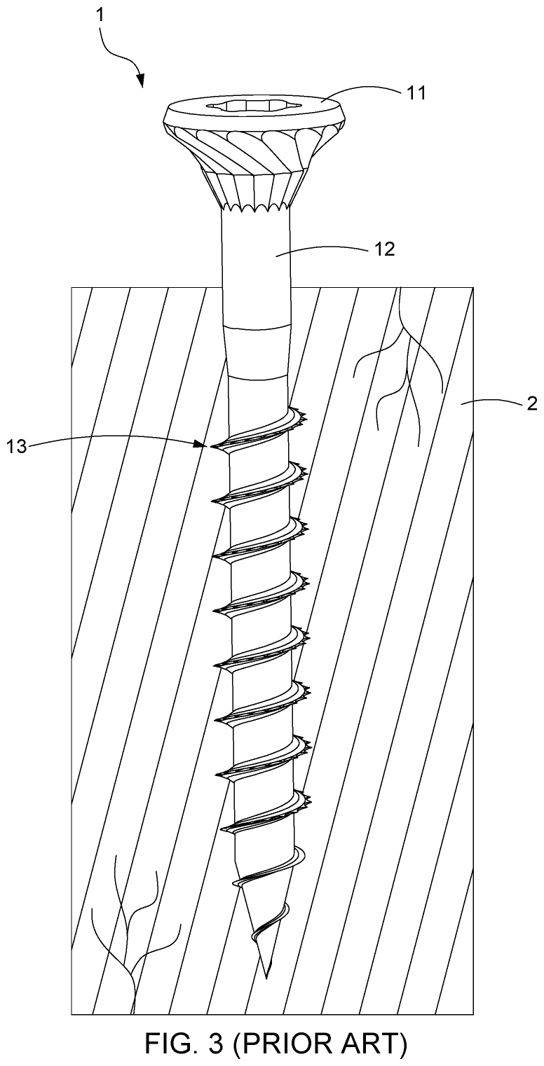

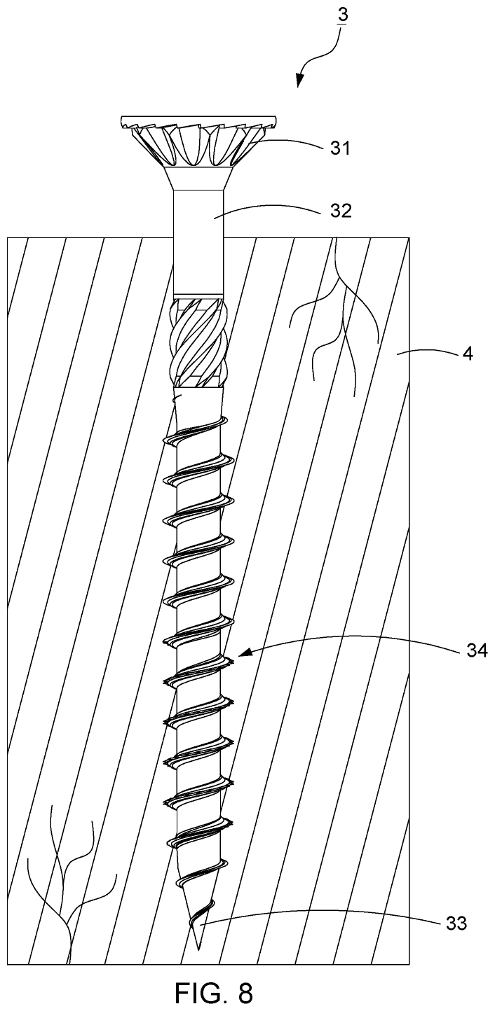

Referring to FIGS. 2 to 8, during a screwing operation of the screw 3, the drill portion 33 is positioned against a surface of a workpiece 4. A rotational force is then applied to the head 31 in order to carry out a cutting operation of the screw 3. The cutting segment 3413A and the severing segment 3413B of the third upper flank section 3413 of each upper thread flank 341 assist the thread crests 343 in improving the cutting sharpness, thereby allowing the thread convolutions 34A to cut into the workpiece 4 sharply and achieving a multi-stage cutting effect. Meanwhile, the third lower flank section 3423 of each lower thread flank 342 helps reduce a contact area between the thread convolutions 34A and the workpiece 4, thereby increasing the cutting capability and allowing the thread convolutions 34A to cut into the workpiece 4 quickly. Because the third lower flank section 3423 of each lower thread flank 342 is extended in a curved manner, thereby allowing cut chips generated during the screwing operation to be discharged outwards speedily. The cut chips also can be discharged outwards through the first lower flank section 3421 of each lower thread flank 342 that is also extended in a curved manner, thereby allowing the screw 3 to enter into the workpiece 4 smoothly, reducing the screwing resistance generated during the screwing operation, and enhancing the cutting capability of the thread convolutions 34A.

The two-stage arrangement of each first upper flank section 3411, namely the engaging segment 3411A and the stretching segment 3411B, and the two-stage arrangement of each second lower flank section 3422, namely the connecting segment 3422A and the linking segment 3422B are capable of increasing the thickness of each thread convolution 34A, thereby increasing the strength of the thread convolutions 34A, providing better supporting force, and preventing the thread convolutions 34A from being deformed or damaged during g the screwing operation while bearing larger screwing force. The upper thread flank 341 and the lower thread flank 342 of each thread convolution 34A are formed in an asymmetric manner. The upper thread flank 341 and the lower thread flank 342 are provided with different number and different shape of flank sections respectively, thereby attaining a multi-stage cutting and reaming effect, severing fibers of the workpiece 4 effectively, accelerating the screwing operation, and reducing the screwing resistance greatly.

During the screwing operation, the cutting edges 3442 of the notches 344 also assist the thread convolutions 34A in cutting the workpiece 4, thereby severing the fibers of the workpiece 4 into the cut chips and preventing the shank 32 from being entangled by the fibers. Further, the cut chips are allowed to travel outwards through the chip-guiding surfaces 3441 of the notches 344 quickly, thereby preventing the improper accumulation of the cut chips and preventing an increase of the screwing resistance. After the screwing operation is completed, the curved first lower flank section 3421, the curved third lower flank section 3423, and the notches 344 allow a proper accumulation of the cut chips, thereby achieving a tight engagement between the screw 3 and the workpiece 4 and improving a screwing effect.

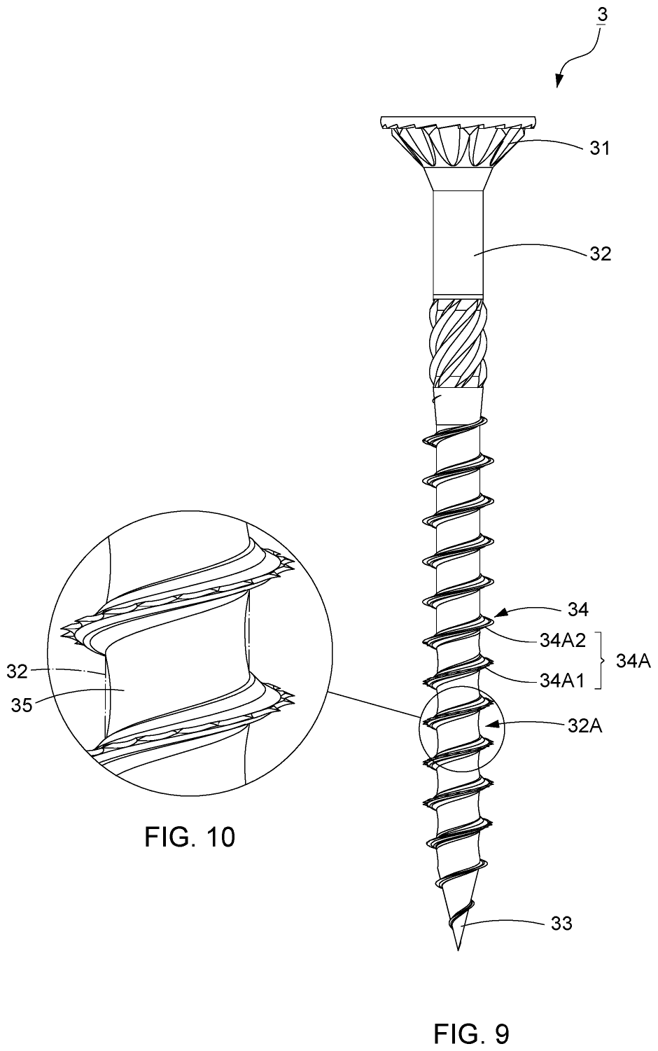

Referring to FIGS. 9 and 10 show a second preferred embodiment of the screw 3 of this invention. The correlated elements and the concatenation of elements, the operation and objectives of the second preferred embodiment are the same as those of the first preferred embodiment. This embodiment is characterized in that the thread convolutions 34A are axially spaced apart so that the shank 32 defines a plurality of surface sections 32A each situated between any two adjacent thread convolutions 34A. At least one surface section 32A is recessedly formed to define an annular groove 35. Thus, the annular groove 35 assists in reducing a contact area between the shank 32 and the workpiece 4 (not shown), thereby attaining a quick removal of the cut chips and a proper accumulation of the cut chips, achieving a tight engagement between the screw 3 and the workpiece 4, and preventing the screw 3 from being loose for attaining an anti-loosening effect.

To sum up, the screw of this invention takes advantages that the upper thread flank and the lower thread flank of each thread convolution are formed in an asymmetric manner, namely the first, second, and third upper flank sections of each upper thread flank are different the first, second, and third lower flank sections of each lower thread flank to thereby attain a multi-stage cutting and reaming effect. The second lower flank section extends straightly to be in a non-curved form between the first and third lower flank sections that are curved in shape, thereby increasing the strength of the threaded portion, providing enough supporting force, severing the fibers of the workpiece effectively, attaining a quick removal and a proper accumulation of the cut chips, reducing the screwing resistance, achieving a tight engagement, accelerating the screwing operation, and improving the screwing effect.

While the embodiments of this invention are shown and described, it is understood that further variations and modifications may be made without departing from the scope of this invention.

What is claimed is:

1. A screw with multiple thread angles comprising:
a head;
a shank extending outwards from said head; and
a threaded portion having a plurality of thread convolutions spirally disposed on said shank, wherein each of said plurality of thread convolutions includes an upper thread flank facing toward said head, a lower thread flank opposite to said upper thread flank, and a thread crest formed along a junction of said upper thread flank and said lower thread flank, a plurality of notches being cut into said thread crest of at least one of said plurality of thread convolutions, with each of said plurality of notches including a chip-guiding surface recessed into said thread crest and two cutting edges formed along an outer periphery of said chip-guiding surface;
wherein said upper thread flank includes a first upper flank section connected to said shank, a second upper flank section connected to said first upper flank section, and a third upper flank section connected to said second upper flank section and extended to said thread crest, said lower thread flank including a first lower flank section connected to said shank, a second lower flank section connected to said first lower flank section, and a third lower flank section connected to said second lower flank section and extended to said thread crest, said first lower flank section and said third lower flank section being curved in shape respectively so that said first lower flank section and said third lower flank section have respective curved surfaces in cross-section, said second lower flank section extending between said first lower flank section and said third lower flank section without bending so that said second lower flank section extends straightly to be in a non-curved form in cross-section.

2. The screw according to claim 1, wherein said second lower flank section includes a connecting segment connected to said first lower flank section and a linking segment extending between said connecting segment and said third lower flank section, connecting segment and said linking segment having said respective second lower sloped surfaces which are different from each other.

3. The screw according to claim 1, wherein said first upper flank section includes an engaging segment connected to said shank and a stretching segment extending between said engaging segment and said second upper flank section, said engaging segment and said stretching segment having respective first upper sloped surfaces which are different from each other.

4. The screw according to claim 1, wherein said second upper flank section is extended straightly to provide a second upper sloped surface.

5. The screw according to claim 1, wherein said third upper flank section includes a cutting segment connected to said second upper flank section and a severing segment extending between said cutting segment and said thread crest, said cutting segment and said severing segment having respective third upper sloped surfaces which are different from each other.

6. The screw according to claim 1, wherein said plurality of thread convolutions includes a first plurality of thread convolutions and a second plurality of thread convolutions, said plurality of notches being recessedly formed on said first plurality of thread convolutions, the number of said first plurality of thread convolutions being in the range of one-third (⅓) to one-half (½) of the number of said plurality of thread convolutions.

7. The screw according to claim 1, wherein said shank defines a plurality of surface sections each situated between any two adjacent thread convolutions when said plurality of thread convolutions are axially spaced apart, at least one of said surface sections being recessedly formed to define an annular groove.
